(19) United States
(12) Patent Application Publication
(10) Pub. No.: US 2007/0272581 A1
(43) Pub. Date: Nov. 29, 2007

(54) Energy absorbing container

(76) Inventors: Benjamin Richard Guelker, Duluth, GA (US); Robert Brett Holben, Roswell, GA (US); Robert Burton Brownell JR., Decatur, GA (US); Russell Joseph Kroll, Atlanta, GA (US); Suzuko Hisata, Atlanta, GA (US); Stephen Joel Zwonitzer, Atlanta, GA (US); Ana Emilia Becker Maciel, Atlanta, GA (US); Steven Craig Vandeberg, Suwanee, GA (US)

Correspondence Address: Judy Jarecki-Black, Ph.D,J.D., 3239 Satellite Blvd., Duluth, GA, 30096, US

(21) Appl. No.: 11/635,838

(22) Filed: Dec. 8, 2006

Related U.S. Application Data
(60) Provisional application No. 60/748,374, filed on Dec. 8, 2005.

(51) Int. Cl. B65D 81/02; B67D 5/06

(52) U.S. Cl. 206/521; 222/183

(57) ABSTRACT

An energy absorbing container including a shell formed of a plastic material, one or more energy absorbing components for absorbing energy resulting from impact loads, the energy absorbing components securing a bottle stored within the container to prevent movement of the bottle within the container, and an opening mechanism for opening the container and allowing the placement or removal of a bottle therefrom.

### RELATED APPLICATIONS

This application claims priority to U.S. provisional application 60/748,374, filed Dec. 8, 2005, herein incorporated by reference.

### INCORPORATION BY REFERENCE

Each document cited in this text (“application cited documents”) and each document cited or referenced in each of the application cited documents, and any manufacturer's specifications or instructions for any products mentioned in this text and in any document incorporated into this text, are hereby incorporated herein by reference; and, technology in each of the documents incorporated herein by reference can be used in the practice of this invention.

It is noted that in this disclosure, terms such as “comprises”, “comprised”, “comprising”, “contains”, “containing” and the like can have the meaning attributed to them in U.S. Patent law; e.g., they can mean “includes”, “included”, “including” and the like. Terms such as “consisting essentially of” and “consists essentially of” have the meaning attributed to them in U.S. Patent law, e.g., they allow for the inclusion of additional ingredients or steps that do not detract from the novel or basic characteristics of the invention, i.e., they exclude additional unrecited ingredients or steps that detract from novel or basic characteristics of the invention, and they exclude ingredients or steps of the prior art, such as documents in the art that are cited herein or are incorporated by reference herein, especially as it is a goal of this document to define embodiments that are patentable, e.g., novel, nonobvious, inventive, over the prior art, e.g., over documents cited herein or incorporated by reference herein. And, the terms “consists of” and “consisting of” have the meaning ascribed to them in U.S. Patent law; namely, that these terms are closed ended.

### FIELD OF THE INVENTION

The present invention is directed to a new and useful apparatus for storing and dispensing liquid and solid agents. Specifically, the present invention is directed to an apparatus for storing and dispensing liquids via a multiuse injection system, wherein the container is designed to resist breaking if dropped.

### BACKGROUND OF THE INVENTION

When dosing a large number of animals in a short period of time, for example in a single veterinary visit to a beef feed lot or to a chicken farm, a veterinarian or animal husbandry worker will often use a dosing gun injector. The dosing gun injector allows the user to dose a large number of animals without having to carry a large number of single dose vials. One such one such dosing gun injector is sold by Merial Ltd., the assignee of the instant application, and is shown in FIG. 1.

The dosing gun injector has a needle in the cap, which is screwed on to the neck of a large vial of vaccine or other treatment to be injected into the animals. The needle in the cap punctures a seal on the container that prevents contamination of the vaccine. The vial is typically turned upside down in order to prevent any air in the vial or dosing gun from being injected into the animals. The vaccine or other treatment is typically injected by depressing some triggering device. As shown in the example of FIG. 1, the two parts of the handle are compressed together, thus pumping a predetermined and metered portion of the treatment through the dosing gun injector.

Traditionally, vaccines and other treatments are stored in glass vials. As can be readily appreciated, glass, though having the beneficial effect of typically not reacting with the material it contains, is relatively hard and readily breakable. Large vials, of the type commonly used with dosing gun injectors, are approximately the size and shape of the bottles shown in FIG. 1A, and generally contain either 500 ml or 250 ml of the treatment. Because this is sufficient vaccine or treatment for dosing a large number of animals, the accidental breakage of such a container can be very costly.

However, despite its breakability, glass remains one of the most common materials for storage of vaccines and other animal treatments. One benefit of glass is that it is not reactive with most treatments, as some plastics can be. Another reason glass continues to be used are the manufacturing costs involved in switching to other materials. Further, because many vaccines are live cultures, they can only properly be stored in sterile containers. As a result of the heat typically necessary for sterilization, glass remains a common choice for storage of vaccines and other animal treatments.

Due to the breakability of glass, attempts have been made to manufacture a shield or protective cover in which to place a glass bottle and prevent its breakage. One example of such a bottle can be seen in FIG. 2, where a protective cover for the drug Micotil is shown. The cover or sleeve in which the glass container is placed is formed of polypropylene and has flanges on both the top and bottom of the sleeve. The flanges help deflect the stresses caused by impact and the bottle is supported in the sleeve at both ends to prevent its movement within the sleeve. However, experience has shown that the approach evidenced by the Micotil protective cover has not proven to be wholly effective in preventing the breakage of bottles stored therein. In particular, this device fails when subjected to localize impacts which are concentrated in a small area. For example, the device shown in FIG. 2 will fail if a stress is imparted to the cover of the device at some point between the two flanges.

Accordingly, the present invention is directed to addressing these problems associated with the known prior art containers.

### SUMMARY OF THE INVENTION

It is an object of the present invention to provide an apparatus to protect a glass bottle from accidental breakage.

It is a further object of the present invention that the apparatus be effective in preventing the breakage of a glass bottle stored therein when dropped on a concrete surface.

It is another object of the present invention that the apparatus be effective in preventing the breakage of a glass bottle stored therein when dropped on either end of bottle.

It is yet another object of the present invention that the apparatus be effective to prevent the breakage of a glass bottle stored therein when dropped from a height of about 36″ (90 cm).

It is a further object of the present invention that the apparatus be effective to prevent the breakage of a glass bottle stored therein when dropped against a hard edge surface impacting a side wall of the apparatus.

It is another object of the present invention that the apparatus be effective when hung upside down.

A further object of the present invention is that the apparatus be usable with both a standard syringe and a dosing gun injector.

It is a further objective of the present invention to provide an apparatus, which accomplishes all of the foregoing objectives in a cost effective manner.

One aspect of the present invention is an energy absorbing container including a shell formed of a plastic material, one or more energy absorbing components for absorbing energy resulting from impact loads, the energy absorbing components securing a bottle stored within the container to prevent movement of the bottle within the container, and an opening mechanism for opening the container and allowing the placement or removal of a bottle therefrom.

The energy absorbing means may isolate the bottle from an inner surface of said shell.

The energy absorbing container may include a void for attachment of a dosing gun injector to the bottle.

The energy absorbing means be pliant fingers.

The energy absorbing container may include a shell that extends past the length of the bottle.

The energy absorbing container may include a shell that is formed of two parts, and these may be connected with snap fittings, a slide locking mechanism, or a flush joint.

The energy absorbing may be formed of three parts, a top part, a bottom part, and a cylindrical lens, that may be connected with a slide locking mechanism.

The energy absorbing container may include one or more energy absorbing means made of foam disks which surrounding the bottle. The foam disks may isolate the bottle from an inner surface of the shell. The foam disks may be held in place by supports

The energy absorbing container may include a shell that is formed of two parts.

The energy absorbing container may include a shell formed of a single piece having a hinge. The shell may have a locking means.

The energy absorbing means may be formed on top and bottom end of a container separated by a cylindrical lens.

The energy absorbing container may include energy absorbing means formed of elastomer or foam bumpers isolating the bottle from the shell. The energy absorbing container of may include a removable base. The energy absorbing container may also include an anti-rolling feature.

The energy absorbing means may be ribs formed within the shell. The ribs may be in both the top and bottom portions of the shell. The ribs isolate the bottle from the shell

The energy absorbing container may include a cover.

The energy absorbing container may include energy absorbing means formed of a bellows within the container. The bellows may be in both the top portion of the container and in a bottom portion of the container. The bellows isolates the bottle from an inner surface of the shell.

The energy absorbing container may also include bell shaped extensions. The bell shaped extensions may have slots machined therein and a hanger. The hanger may incorporate a lock.

Another aspect of the present invention is a method of dispensing a fluid from a dosing gun injector comprising the steps of providing an energy absorbing container having a shell formed of a plastic material, one or more energy absorbing means for absorbing energy resulting from impact loads the energy absorbing means securing a bottle stored within the container to prevent movement of the bottle within the container, and an opening means for opening the container and allowing the placement or removal of a bottle therefrom. The method also includes a step of attaching the energy absorbing container, having a bottle placed therein to a dosing gun injector, and depressing a trigger located on said dosing gun thereby dispensing fluid contained within said bottle from said dosing gun injector.

Yet a further aspect of the present invention is a method for protecting a bottle employed with a dosing gun injector comprising the steps of providing an energy absorbing container having a shell formed of a plastic material, one or more energy absorbing means for absorbing energy resulting from impact loads, the energy absorbing means secures a bottle stored within the container to prevent movement of the bottle within the container, and an opening means for opening the container and allowing the placement or removal of a bottle therefrom. The method also includes steps of inserting a bottle in the energy absorbing container, and attaching the energy absorbing container, having a bottle placed therein to a dosing gun injector.

These and other embodiments are disclosed or are obvious from and encompassed by, the following Detailed Description.

### BRIEF DESCRIPTION OF THE DRAWINGS

The following Detailed Description, given to describe the invention by way of example, but not intended to limit the invention to specific embodiments described, may be understood in conjunction with the accompanying Figures, incorporated herein by reference, in which:

FIG. 1 is a profile view of an exemplary dosing gun injector;

FIG. 1A is a profile view of bottles which may be used with the present invention;

FIG. 2 is a profile view of a known protective cover;

FIG. 3 is a cross-sectional view of a container according to one aspect of the present invention;

FIG. 4 is a cross-sectional view of a container according to one aspect of the present invention;

FIG. 4a is a cross-sectional view of a locking mechanism according to one embodiment of the present invention;

FIG. 5 is a cross-sectional view of a container according to one aspect of the present invention;

FIG. 6 is a cross-sectional view of a container according to one aspect of the present invention;

FIG. 7 is a cross-sectional top view of a container according to one aspect of the present invention having a hinge;

FIG. 8 is a plot of toughness v. strength of a variety of materials usable with one or more aspects of the present invention;

FIG. 9 is a perspective view of a container according to one aspect of the present invention;

FIG. 10 is a cross-sectional view of a container according to one aspect of the present invention;

FIG. 11 is a perspective view of a container according to one aspect of the present invention;

FIG. 12 is a cross-sectional view of a container according to one aspect of the present invention;

FIG. 13 is a perspective view of a container according to one aspect of the present invention;

FIG. 14 is a cross-sectional view of a container according to one aspect of the present invention;

FIG. 15 is a perspective view of a container according to one aspect of the present invention;

FIG. 16 is a cross-sectional view of a container according to one aspect of the present invention;

FIG. 17 is a perspective view of a container according to one aspect of the present invention;

FIG. 18 is a cross-sectional view of a container according to one aspect of the present invention.

### DETAILED DESCRIPTION

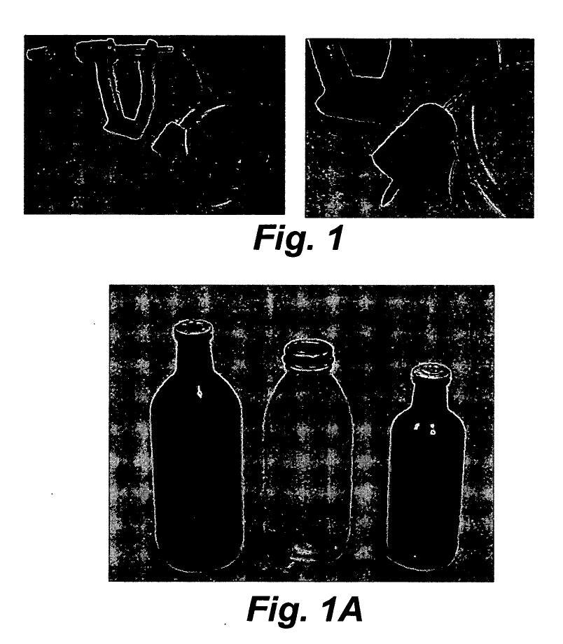

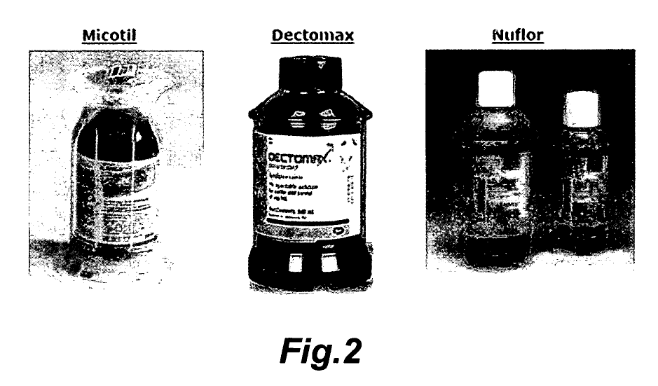

In order to develop a container for a glass bottle that prevents breakage and addresses one or more of the objectives described above, tests were undertaken to determine the properties of a glass container in various states and the stresses such a container will withstand without breaking. In a first test, a filled unprotected 250 ml bottle of the type shown in FIG. 1A having an approximate thickness of between 1/16 to ⅛ of an inch (approximately 0.16-0.32 cm) was tested by dropping it flat against a hard surface, a concrete floor. It was determined that a glass bottle will break if dropped from a height of about 18-22 inches (approximately 45-56 cm). However, if an edge bearing surface, such as a piece of angle iron is placed so that on impact the side of glass bottle impacts the edge of the angle iron at approximately its center point, a glass bottle will break when dropped at between 12 and 17 inches (approximately 30-43 cm).

A second test was conducted to determine whether the use of a simple polypropylene sleeve would provide sufficient protection to prevent breakage of the glass container. A plastic sleeve was place around a 500 ml bottle, having an approximate thickness of between 1/16 and ⅛ of an inch (approximately 0.16-0.32 cm). The sleeve was separated from the bottle by rigid plastic so that the outer diameter of the bottle and sleeve was about 3¼″ (approximately 8.3 cm), and there was about 0.06″ (approximately 0.15 cm) separating the polypropylene sleeve from the glass. The results were that the bottle failed a side impact on a level surface when dropped from about 24-30″ (approximately 60-76 cm), however, a bottle so arranged in a polypropylene sleeve did survive drops of 36″ (about 90 cm) when dropped on either end of the bottle and sleeve arrangement. Again, when dropped onto an edge bearing surface such as angle iron, the bottle suffered failure at heights of only 16-18″ (approximately 40-45 cm).

A third test was undertaken wherein a glass bottle was placed in an extruded PVC sleeve. The sleeve has a thickness of about 0.08″ (about 0.2 cm). The PVC sleeve was fitted with machined polypropylene caps, which prevent the bottle from sliding out of the ends of the sleeve. The caps have a diameter of about 4.2 inches (about 10.7 cm), while the sleeve has a diameter of about 3.9 inches (about 9.9 cm). The bottle, when properly set in the sleeve is isolated from the inner wall of the sleeve by about 0.5″ (about 1.2 cm). The sleeve is actually shorter than the length of the bottle, with the ends of the bottle resting against and being covered by the caps. Tests of this configuration confirmed that on flat surfaces such as concrete the height required for breakage of the bottle was at least 54″ (about 137 cm). Similarly, when dropped onto an edge bearing surface, the breakage height was between 54 and 60″ (about 137-152 cm).

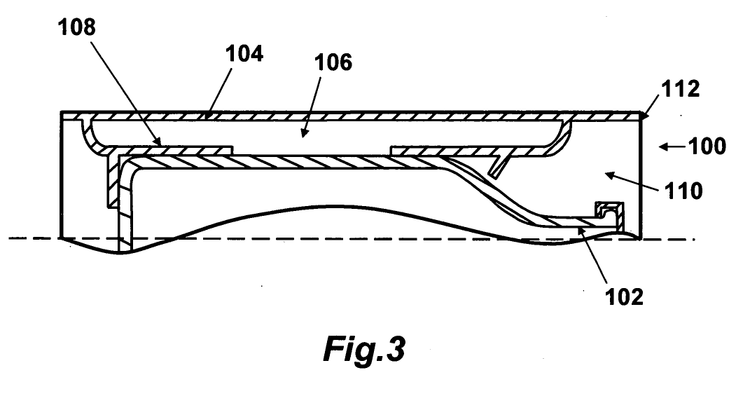

FIG. 3 depicts a cross sectional view of a container 100 according to one aspect of the present invention. The container 100 holds a bottle 102. The container 100 is formed with an outer surface 104, which is separated from the bottle by a void space 106. The bottle 102 is secured in the container 100 through use of pliant energy absorbing members 108. In the example shown in FIG. 3, the energy absorbing members 108 are formed of the same material as the container 100, and may be formed integrally therewith. The energy absorbing members 108 deflect upon application of a force thereto. For example in a situation where the container 100 houses a bottle 102 and is dropped, the energy from the falling bottle is translated into the energy for deflecting the energy absorbing members 108. These energy absorbing members 108 also hold the bottle 102 against one another in order to prevent the bottle 102 from moving within the container 100. As shown in FIG. 3, the energy absorbing members are shaped so as to absorb energy of impact both when the container 100 is dropped on its side, as well as when dropped on either end of the container 100. The container 100 also includes extensions 112 which extend beyond the ends of the bottle 102 and form a void 110. The void 110 is useful in allowing the application of, for example, a dosing gun injector as shown in FIG. 1. The extensions 112 also help prevent impact to the ends of the bottle 102. One preferred aspect of the present invention is that it is formed of a material that is essentially clear and allows for easy reading of a label placed on the bottle 102.

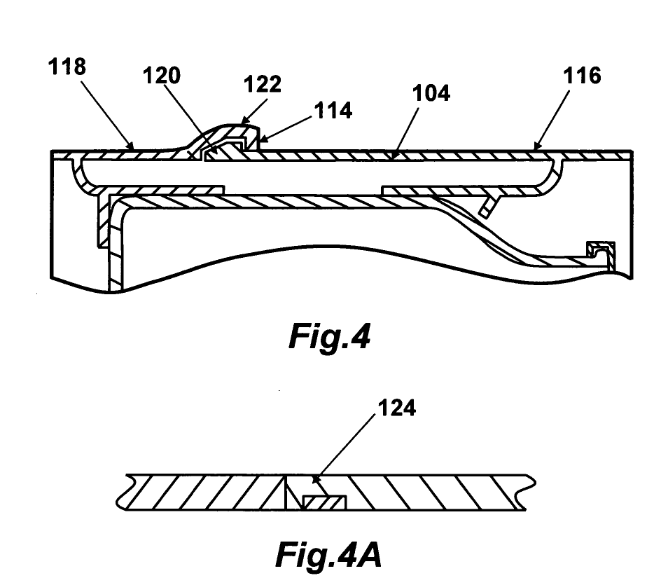

A further example of the present invention is shown in FIGS. 4 and 4a. FIG. 4 shows a two-piece container which includes a lock mechanism 114. FIG. 4 shows a sliding lock mechanism 114 which allows a user to insert a first portion 116 of the container 100 into a second portion 118. An angled surface 120 of the sliding lock mechanism 114 allows for the first portion 116 of the container 100 to be displaced inward towards the bottle 102 and be secured by a receiving portion 122 of the sliding lock mechanism 114. The sliding lock mechanism 114 can be opened by application of force to the outer surface 104 of the first portion 116, which will cause the first portion 116 to deflect inward towards the bottle 102 and allow for the angled portion 120 of the sliding lock mechanism 114 to be removed from the receiving portion 122.

FIG. 4a shows an alternative to the sliding lock mechanism 114 shown in FIG. 4, a flush joint 124. The flush joint operates substantially similarly to the slide locking mechanism, in that it allows for the securing of a first portion 116 of the container 100 to the second portion 118. The flush joint 124 is comprised of two substantially identical tab and notch sections formed one on the first section 116 and second section 118 of the container 100. Again, the flush joint 124 can be opened by application of pressure to the outer surface 104 of the first portion 116 of the container 100, which deflects the tab of the first portion 116 out of the notch of the second portion and simultaneously the tab of the second portion 118 from the notch of the first portion 116. As a result the first portion 116 can be separated from the second portion 114 of the container 100.

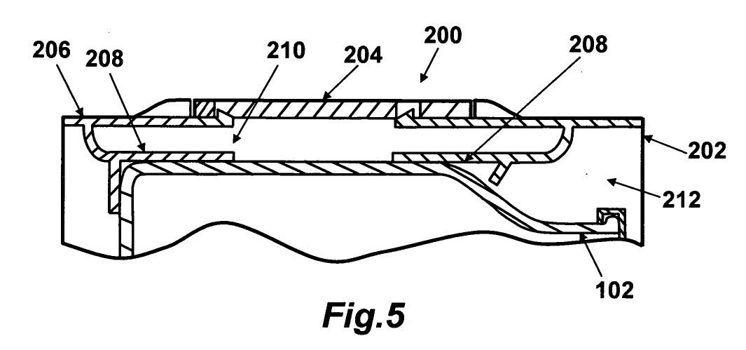

Another aspect of the present invention is shown in FIG. 5, a three-part container 200. The three-part container 200 includes a top end cap 202, which substantially conforms with and supports a top portion of the bottle 102. The three-part container also includes a cylindrical sleeve 204, which surrounds the bottle 102. Finally, the three-part container also includes a bottom end cap 206, which substantially conforms with and supports a bottom portion of the bottle 102.

The cylindrical sleeve according to one aspect of the invention is extruded and then has a locking mechanism such as a slide lock mechanism machined into the sleeve. Another aspect of the invention is that the end caps 202 and 206 are molded to include energy absorbing or shock absorbing members 208. As with the embodiment shown in FIG. 3, the example shown in FIG. 5 includes a void space 210 separating the inner surface of the sleeve 204 from the bottle 102. Similarly, the container 200 includes a void 212, which protects the top portion of the bottle 102 and allows for access to the bottle 102 by either a syringe or a dose gun injector.

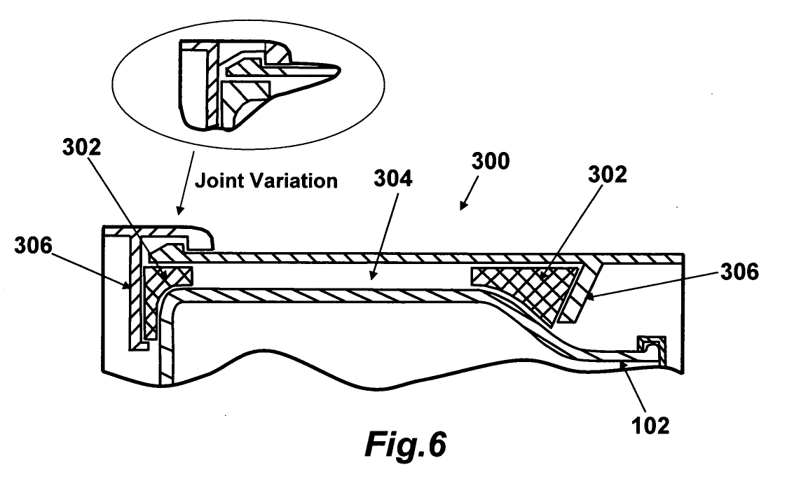

Another aspect of the present invention is shown in FIG. 6 in which depicts a second two piece container 300. The container 300 is similar to that shown in FIG. 4, however, the energy absorbing members 108, have been replaced with cushioning members 302, made of for example Styrofoam. Other materials could also be used to cushion the bottle 102 stored within the container 300. Like the energy absorbing members, the cushioning members 302 isolate the bottle 102 from the container 300 and create a void 304. The cushioning members 302 also secure the bottle 102 within the container 300 and prevent it from moving around. The cushioning members 302 may be held in place by supports 306.

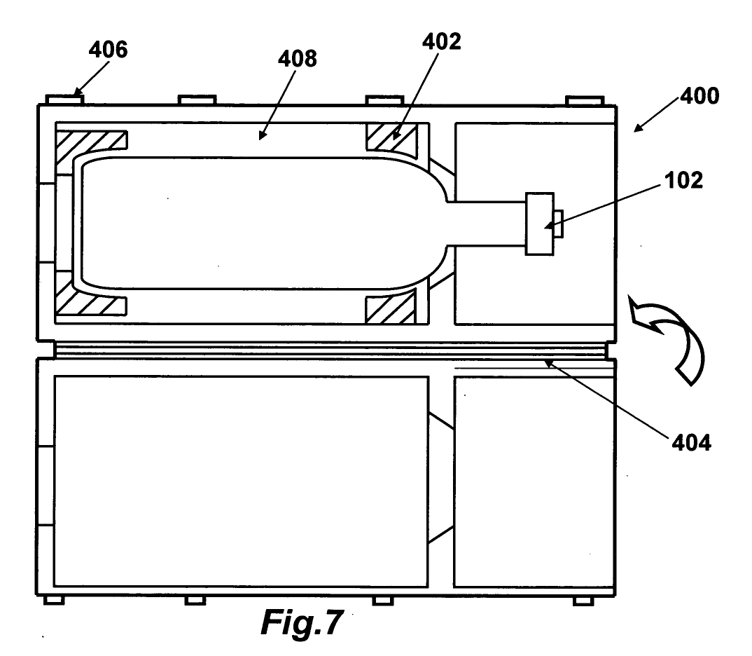

Yet a further aspect of the present invention is shown in FIG. 7. The container 400 shown in FIG. 7 is a single piece having two halves joined by a hinge 404. The container 400 includes cushioning members 402, which isolate the bottle 102 from the container 400, and create a void 408 between the container 400 and the bottle 102. As shown, the container 400 is in the open position. The hinge 404 allows the two halves of the container to be folded onto one another to fully enclose the bottle 102. Once enclosed, closure devices 406, located on the edge of the two halves which are brought together to enclose the bottle 102, provide a securing means for locking the bottle 102 in the container 400 and preventing accidental opening. One of skill in the art will appreciate that any number of different closure devices 406 could be used in accordance with the present invention including snaps, buckles, slides, hook and loop fasteners, and others. Additionally, one of skill in the art will appreciate that while shown in FIG. 7 using the cushioning members 402, energy absorbing members as shown in FIG. 3 could also be used without departing form the teachings of the present invention. The one-piece construction as shown in FIG. 7 has the additional benefit that such a device lends itself to thermal forming methods which helps to reduce machining and production costs.

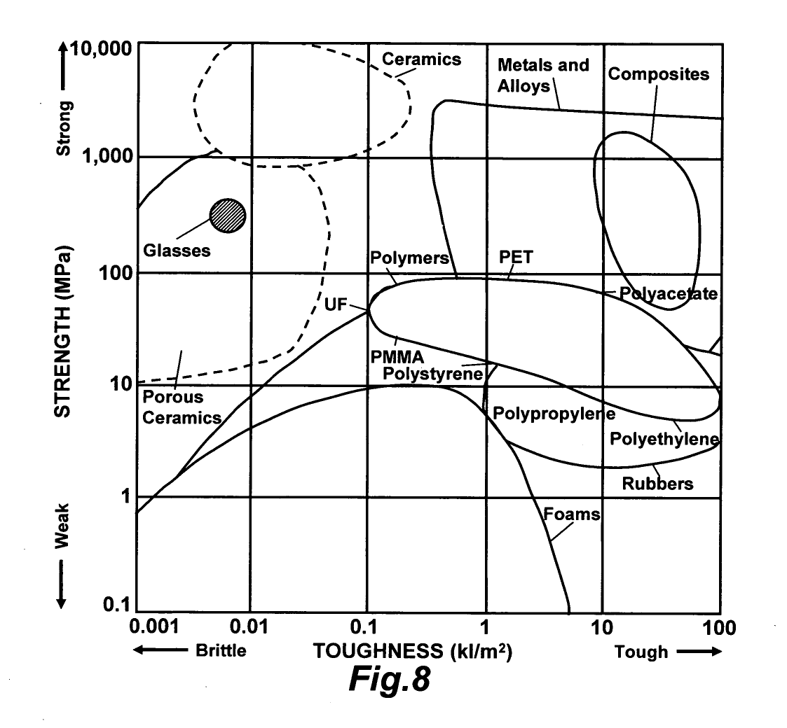

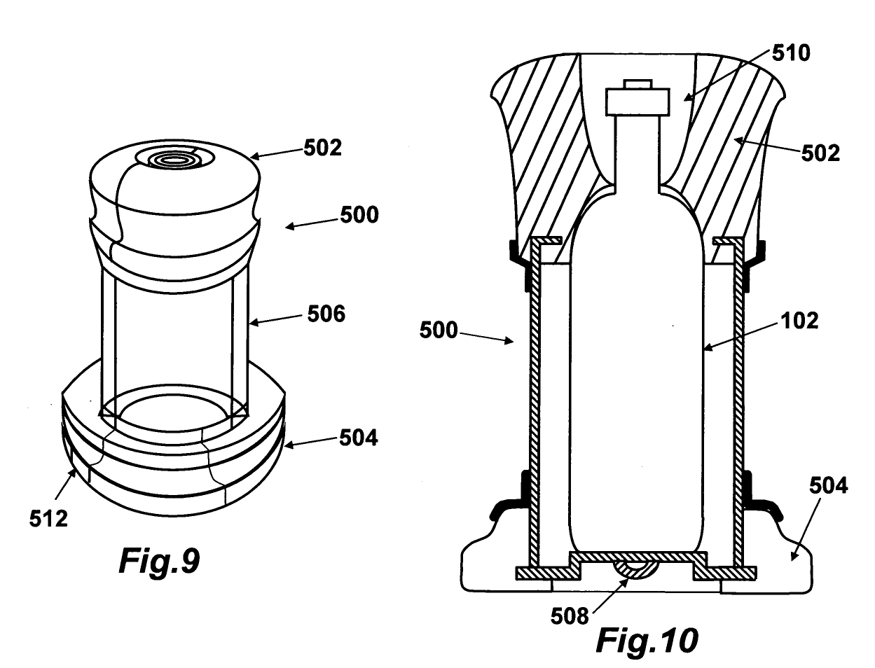

Additional aspects of the present invention can be seen with references to FIGS. 9-18. FIGS. 9 and 10 depict a container 500 having molded top and bottom caps 502 and 504. These molded top and bottom caps act as cushioning member to absorb energy generated from impact to either end of the container 500. The molded caps 502 and 504 may be formed for example from Styrofoam. In addition, the molded caps hold the bottle 102 securely in place and substantially prevent its movement within the container 500. The container 500 also includes a clear or substantially clear cylindrical lens 506. The cylindrical lens 506 may be formed of a relatively hard plastic such as acrylic, and allows for a user to see the bottle 102 housed within the container 500. The container 500 also includes a void 510, which allows for access to the bottle 102 by a syringe or dosing gun injector. Another aspect of the container 500 is a hanging point 508, which allows the user to suspend the container 500 from a hook to prevent the injection of air when used, as discussed above. Yet a further aspect of the container 500 is one or more flats 512 formed on the sides of the end cap 504. These flats prevent the container 500 from rolling when placed on a flat surface. One of skill in the art will appreciate that such flats may also be formed on the end cap 502.

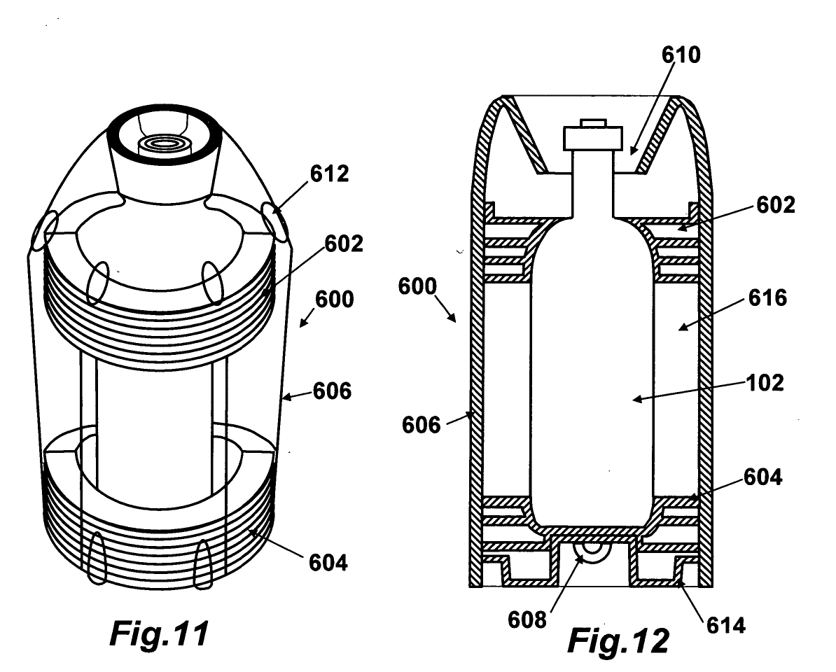

Another aspect of the present invention is shown in FIGS. 11 and 12 where container 600 is depicted. The container 600 includes bumpers or cushioning members 602 and 604, which surround a bottle 102, and are themselves encased in a shell 604. As shown in FIG. 12, the bottle 102 is held by and against the cushioning members 602 and 604. The cushioning members may be formed of an elastomeric material such rubber or of a molded foam such as Styrofoam. The cushioning members 602 and 604 also isolate the bottle 102 from the shell 606 of the container 600. A bottom cover 614 prevents the bottle 102 from falling out the bottom of the container 600, and may be press fit or screwed into the container 600. A void 610 is located at the top of the container 600 to allow for access to the bottle by a syringe or dosing gun injector. As with the device shown in FIGS. 9 and 10 the aspect of the invention shown in FIGS. 11 and 12 also has a hanging point 608 allowing a user to suspend the container 600. The shell of the container may also include bumps 612 which prevent the container from rolling when placed on its side.

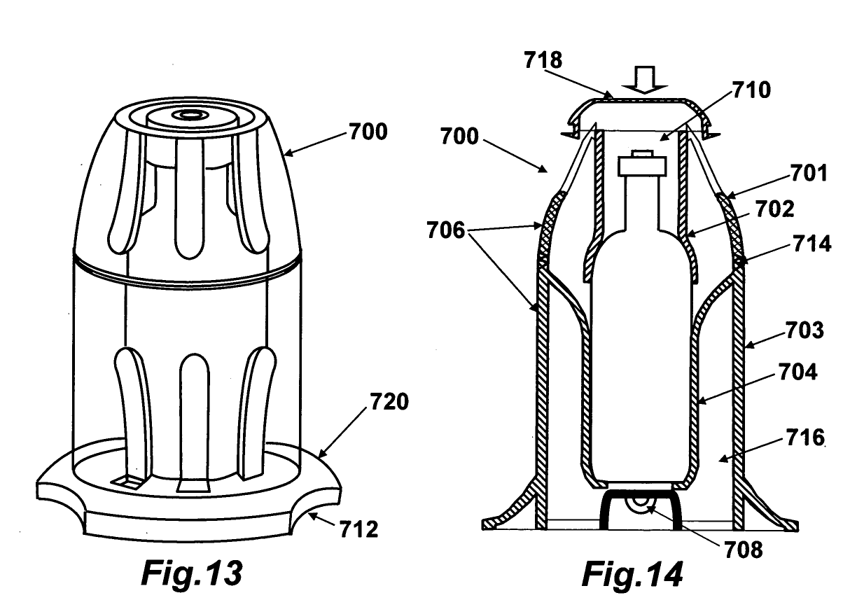

A further aspect of the present invention can be seen with reference to FIGS. 13 and 14 showing a container 700. The container 700 has a shell 706 formed of a top portion 701 having ribs 702 for absorbing impact loads and for supporting the bottle 102. The container 700 is also formed of a bottom portion 703 having ribs 704 also for absorbing impact loads and for supporting the bottle 102. The top and bottom portions 701 and 703 may be joined for example by threads 714. Alternative means for joining the top and bottom portions such a snaps, clasps, etc., will be readily apparent to those of skill in the art. The ribs 702 and 704 isolate the bottle 102 from the shell 706 and create a void 716 therebetween. A further void 710 is formed in the top portion 701 to allow for access for syringes or dosing gun injectors by the user. A further aspect of the device shown in FIGS. 13 and 14 is a cover 718, which prevents debris and dirt from contaminating the container 700 or the bottle 102. As with the device shown in FIGS. 9 and 10 the aspect of the invention shown in FIGS. 13 and 14 also has a hanging point 708 allowing a user to suspend the container 700. The container 700 also may include divots 712 which prevent the container 700 from rolling when placed on a flat surface. A base 720, having a diameter greater than the diameter of the shell 706 may also be included to increase the stability of the container 700 when placed in an upright position. The entire container 700 may be formed of a single type of plastic. Alternatively, the ribs 702 and 704 may be formed of a second type of plastic and inserted into the container 700.

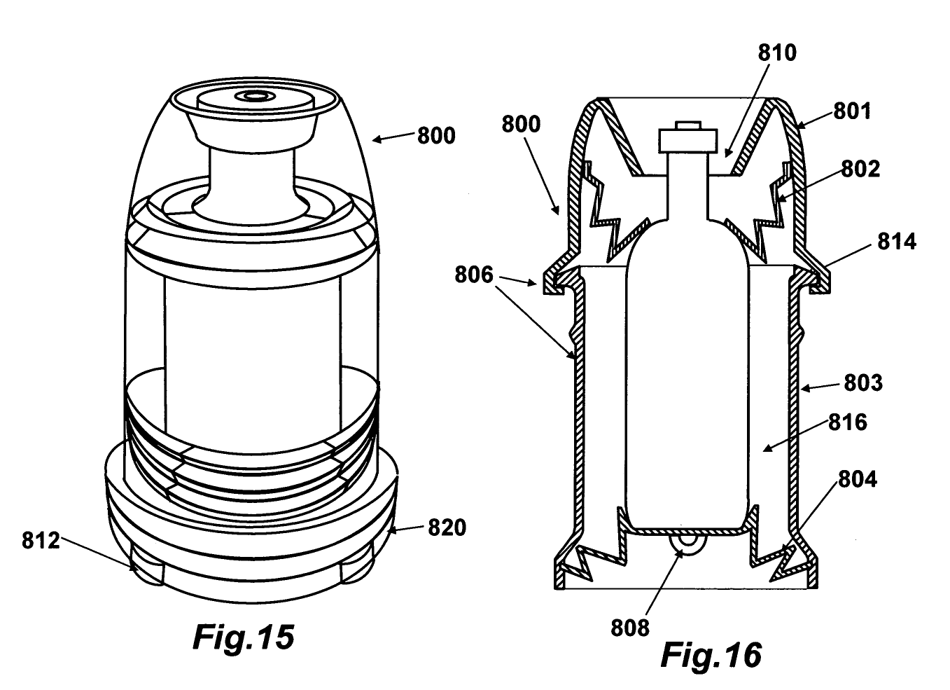

Another aspect of the present invention is shown in FIGS. 15 and 16 depicting a container 800. The container 800 is similar to the container 700 shown in FIGS. 13 and 14, having a top portion 801 and bottom portion 803 each containing an energy absorbing bellows 802 and 804 respectively. The bellows 802 and 804 as shown are molded into the bellows form and then attached to the inside of the shell 806, for example by spin welding. The bellows 802 and 804 isolate the bottle 102 from the shell 806 and create a void 816 and act to absorb impact energy. The top portion 801 and bottom portion 803 are connectable for example by a snap fit closure 814. Alternate closure means are considered within the scope of the present invention. The container 800 also includes hanging means 808, and a void 810 is formed in the top portion 801 to allow access for syringes and dosing gun injectors. The container 800 may also include an anti-roll feature 812 to prevent rolling of the container 800 when placed on a flat surface as well as a base 820 having a wider diameter than the shell 806 for increased stability when placed in the upright position.

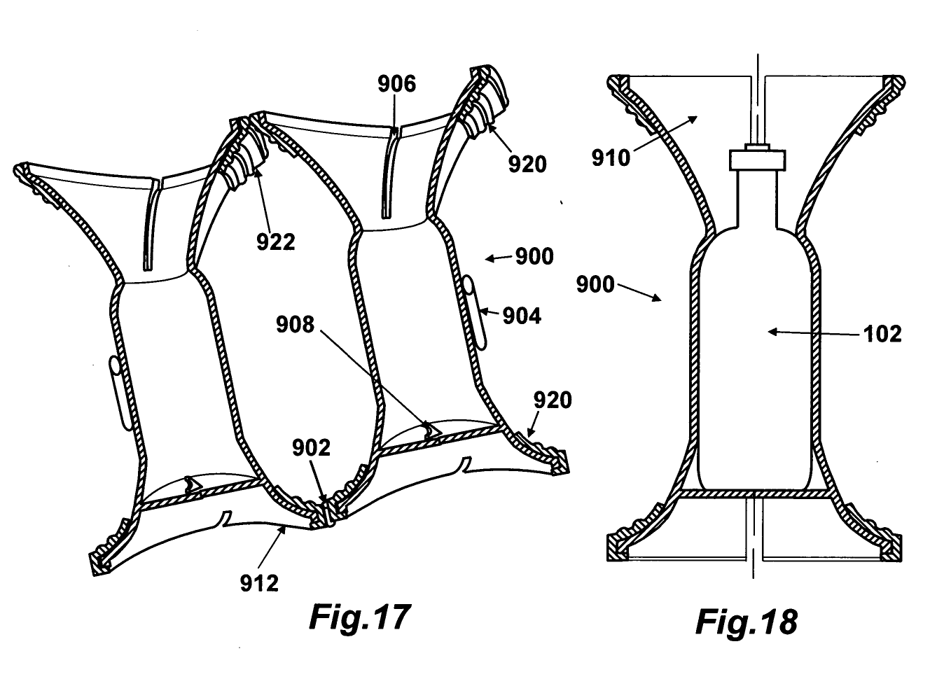

A further aspect of the present invention showing the use of a hinge 902 as discussed above is shown in FIGS. 17 and 18 depicting container 900. The container 900 includes a snap fit closure 904, and may also include a snap fit hanging means 908 which assist in ensuring secure closure of the container 900. The container 900 also includes bell shaped extensions 920 on both top and bottom ends of the container. The bell shaped extensions 920 act as energy absorbing means for absorbing impact loads when the container 900 is dropped. To assist in absorbing energy from impact the bell shaped extensions 920 contain one or more slots 906 cut into the bell shaped extension. These slots 906 allow at least a portion of the bell shaped extension 920 to deflect upon impact and further cushion the bottle 102 housed within the container 900. The bell shaped extensions may also include an overmold portion 922 of greater thickness than the rest of the bell shaped extension, which provides for greater strength and resistance to deflection, thus providing greater cushioning effect for the bottle 102. Also, as shown in FIG. 17, flats 912 may also be included in the container 900 to assist in resisting rolling of the container when placed on a flat surface.

A variety of materials may be used in conjunction with the components of the containers described herein. The materials can be extruded, machined, or worked by a variety of means so as to provided sleeves and caps, which may be attached to one another by a variety of means including adhesives, snaps, hook and loop fastening, threads, and other attachments means known to those of skill in the art. Among the materials useable with the present invention are hard plastics such as acrylic, for the shell or the cylindrical lens other materials could also be used such as polyethylene terephthalate (PET), polyvinyl chloride (PVC), polypropylene (PP), ABS plastics, Nylon, polybutylene terephthalate (PBT), polyethylene, such as High Density Polyethylene (HDPE), High Density Polypropylene (HDPP), polycarbonate, polystyrene such as high impact polystyrene (HIP), thermoplastic olefins (TPO's), polyesters, polyurethanes (PU), polyamides, and others. Examples of such additional plastics include those regularly used in the automotive industry for use in the manufacture of plastic parts including bumpers. According to the 2001 Automotive Plastics Report, published by Market Search, Inc., the most commonly used plastics are shown below:

| Polymer | 1996 | 2001 | 2006 | 2011 |
|---|---|---|---|---|
| ABS | 201.8 | 173.5 | 142.8 | 116.8 |
| Nylon (PA) | 300.8 | 341.5 | 406.4 | 494.2 |
| Polycarbonate (PC) | 87.5 | 84.9 | 93.7 | 106.6 |
| Polyester (TP) | 133.0 | 129.2 | 144.0 | 161.1 |
| Polyester (TS) | 234.5 | 186.0 | 260.3 | 384.7 |
| Polyethylene (PE) | 365.6 | 437.2 | 509.0 | 587.5 |
| Polypropylene (PP) | 642.5 | 681.9 | 767.4 | 919.2 |
| Polypropylene (EDPM) | 157.9 | 375.1 | 436.0 | 509.7 |
| Polyurethane (PUR) | 831.4 | 792.5 | 914.2 | 1,123.2 |
| Polyvinylchloride (PVC) | 381.5 | 390.0 | 403.1 | 412.0 |
| Total | 5332.5 | 5592.8 | 6082.9 | 6,826 |

2001 Automotive Plastics Report, published by Market Search, Inc. http://www.plastics-car.org/s plasticscar/doc.asp
In addition, the plastics used for the sleeve may be made of blends of two or more of the above-identified materials.

Foams for use with the instant invention include polystyrene foam such as Styrofoam, cellular foam such as Poron®, pure gum foam rubber, silicone foam, neoprene foam, polypropylene EPDM foam, polyethylene foam, polyurethane and others. Elsastomeric materials include Santoprene, Silicone, Neoprene, Buna-N and others. One further alternative to foam materials are the use of air, liquid, or gel filled pillows made of for example polyethylene pr polypropylene flexible plastics.

Finally, although in some embodiments it is preferred that the sleeve be substantially clear so that the contents may be examined without opening the sleeve, in others it may be desirable that a tinting if given to the sleeve to prevent the transmission of ultraviolet rays onto the treatment contained within the bottle, the tinting may be of a color to reflect light energy such as white. In addition, it may be desirable that the end caps be made of a color or light orange such as white that reflects light energy so as to prevent the heating of the treatment contained therein.

Having thus described in detail preferred embodiments of the present invention, it is to be understood that the invention defined by the appended claims is not to be limited to particular details set forth in the above description as many apparent variations thereof are possible without departing from the spirit or scope of the present invention.

1. An energy absorbing container comprising;
a shell formed of a plastic material;
one or more energy absorbing means for absorbing energy resulting from impact loads, said energy absorbing means securing a bottle stored within said container at a predetermined distance from the shell to prevent movement of said bottle within the container; and
an opening means for opening said container and allowing the placement or removal of a bottle therefrom.

2. The energy absorbing container of claim 1 wherein said energy absorbing means isolates the bottle from an inner surface of said shell.

3. The energy absorbing container of claim 1 further comprising a void for attachment of a dosing gun injector to the bottle.

4. The energy absorbing container of claim 1 wherein the energy absorbing means are pliant fingers.

5. The energy absorbing container of claim 1, wherein the shell extends past the length of the bottle.

6. The energy absorbing container of claim 1, wherein the shell is formed of two parts.

7. The energy absorbing container of claim 6, wherein the two parts of the shell are connected with a snap fitting.

8. The energy absorbing container of claim 6, wherein the two parts of the shell are connected with a slide locking mechanism.

9. The energy absorbing container of claim 6, wherein the two parts of the shell are connected with a flush joint.

10. The energy absorbing container of claim 1, wherein the container is formed of three parts, a top part, a bottom part, and a cylindrical lens.

11. The energy absorbing container of claim 10, wherein the three parts are connected with a slide locking mechanism.

12. The energy absorbing container of claim 1, wherein one or more energy absorbing means are foam disks surrounding the bottle.

13. The energy absorbing container of claim 12, wherein in the foam disks isolate the bottle from an inner surface of the shell.

14. The energy absorbing container of claim 12, wherein the shell is formed of two parts.

15. The energy absorbing container of claim 12, wherein the foam disks are held in place by supports.

16. The energy absorbing container of claim 1, wherein the shell is formed of a single piece having a hinge.

17. The energy absorbing container of claim 16, wherein the shell has locking means for securing the bottle within the container.

18. The energy absorbing container of claim 1, wherein the one or more energy absorbing means are foam disks.

19. The energy absorbing container of claim 1, wherein the energy absorbing means are formed on top and bottom end of said container separated by a cylindrical lens.

20. The energy absorbing container of claim 1, wherein the energy absorbing means are elastomer or foam bumpers isolating the bottle from the shell.

21. The energy absorbing container of claim 20, further comprising a removable base.

22. The energy absorbing container of claim 20, further comprising an anti-rolling means.

23. The energy absorbing container of claim 20, further comprising a hanger means.

24. The energy absorbing container of claim 1, wherein the energy absorbing means are ribs formed within the shell.

25. The energy absorbing container of claim 24 wherein the shell is comprised of a top portion and a bottom portion.

26. The energy absorbing container of claim 25, wherein a portion of the ribs are in both the top and bottom portions of the shell.

27. The energy absorbing container of claim 25, wherein the ribs isolate the bottle from the shell

28. The energy absorbing container of claim 24, further comprising a cover.

29. The energy absorbing container of claim 24, further comprising an anti-roll means.

30. The energy absorbing container of claim 1, wherein the energy absorbing means are bellows formed within the container.

31. The energy absorbing container of claim 30, comprising a top bellows in a top portion of the container and a bottom bellows in a bottom portion of the container.

32. The energy absorbing container of claim 30, wherein the bellows isolate the bottle from an inner surface of the shell.

33. The energy absorbing container of claim 1, wherein the shell is formed of a single piece construction having a hinge.

34. The energy absorbing container of claim 1, further comprising bell shaped extensions.

35. The energy absorbing container of claim 34, wherein the bell shaped extensions have slots machined therein.

36. The energy absorbing container of claim 34 further comprising a hanging means, wherein the hanging means incorporates a locking means,

37. A method of dispensing a fluid from a dosing gun injector comprising the steps of:
providing an energy absorbing container having a shell formed of a plastic material, one or more energy absorbing means for absorbing energy resulting from impact loads said energy absorbing means securing a bottle stored within said container at a predetermined distance from the shell to prevent movement of said bottle within the container, and an opening means for opening said container and allowing the placement or removal of a bottle therefrom;
attaching the energy absorbing container, having a bottle placed therein to a dosing gun injector; and
depressing a trigger located on said dosing gun thereby dispensing fluid contained within said bottle from said dosing gun injector.

38. A method for protecting a bottle employed with a dosing gun injector comprising the steps of:
providing an energy absorbing container having a shell formed of a plastic material, one or more energy absorbing means for absorbing energy resulting from impact loads said energy absorbing means securing a bottle stored within said container at a predetermined distance from the shell to prevent movement of said bottle within the container, and an opening means for opening said container and allowing the placement or removal of a bottle therefrom;
inserting a bottle in said energy absorbing container; and
attaching the energy absorbing container, having a bottle placed therein to a dosing gun injector.
